(19) United States
(12) Patent Application Publication
(10) Pub. No.: US 2009/0315901 A1
(43) Pub. Date: Dec. 24, 2009

(54) ELECTRONIC PAPER PANEL IMAGE UPDATE METHOD

(76) Inventors: Feng Qiao, Beijing (CN); Pingfen Lin, Beijing (CN); Yuming Fang, Beijing (CN); Yang Zhou, Beijing (CN); Jingyu Liu, Beijing (CN)

Correspondence Address: J.C. Patents, Suite 250, 4 Venture, Irvine, CA, 92618, US

(21) Appl. No.: 12/323,334

(22) Filed: Nov. 25, 2008

(30) Foreign Application Priority Data
Jun. 18, 2008 (CN) 200810115107.5

(51) Int. Cl. G06T 1/00

(52) U.S. Cl. 345/522

(57) ABSTRACT

A updating method of images in electronic paper panel includes: divide the screen and image into (N*N) areas and build indexes for them; compare the present image on the display screen with the next image and compute the different areas; according to the computing result, find the uppermost, undermost, leftmost and rightmost different areas and compute the area of the smallest rectangle which includes the different areas; compare the result with the configured threshold and according to this compared result, set up the updating method to display the image. This method effectively reduces the data of updating images and save the power of the electronic paper, especially the power of the electronic paper panel. It can also improve the response time of the electronic paper panel. At the same time, it is easy to be ported to other advanced embedded operating systems. Thus, it could provide an effective method for the products related to the electronic paper.

### CROSS-REFERENCE TO RELATED APPLICATION

This application claims priority benefit of Chinese application No. 200810115107.5, filed on Jun. 18, 2008, the content of which is hereby incorporated by reference in its entirety.

### FIELD OF THE INVENTION

This invention is related to a method of updating images, especially about the electronic paper panel in electronic products.

### BACKGROUND OF THE INVENTION

In recent years, a called “electronic paper”, the display screen being as flexible as paper, becomes more and more popular. It could keep the image on the display screen in no-power status. The electronic paper is an electronic device used to read books. It has many advantages including: the high compared depth, the distinct words, the hand-writing character, low-power consuming and the flexible character. Images on this electronic paper could be eliminated and rewritten and thus this could cause saving many sources.

Because of the above advantages of the electronic paper, many electronic products using the electronic paper as display screen are emerging. However, there is a limitation with the present electronic products: there is no effective method of updating images on the electronic paper panel, which would cause the delay of display images and the increase of power.

### SUMMARY OF THE INVENTION

One aspect of this invention is to improve the response time of updating images, decrease the power of the display screen in this electronic paper and decrease the data of updating images through computing the area of the display screen in this electronic paper.

This invention is implemented through the following technologies:

A method of updating images on the electronic paper panel, including the following steps:

(1) Divide the screen and image into (N*N) and build indexes for them, compared the present image of the display screen with the next image which will display to compute the different areas.

(2) According to the above results, find the uppermost, undermost, leftmost, and rightmost different areas; compute the area of the smallest rectangle including the different areas.

(3) The above result is the area of the updating part of the image; compare this area with the configured threshold; according to the compared result, set up the method of updating image to display the image.

The resolution of the above described the electronic paper panel changes from 32*32 pixels to 1920*1920 pixels.

The resolution of the above described images change from 32*32 pixels to 1920*1920 pixels.

The gray degree and color depth of the above described images change from black-white to true color 32-bit.

The algorithm of the above smallest rectangle is as follows:

Step1: compute the uppermost, undermost, leftmost and rightmost indexes of different areas.

Step2: compute the area of the rectangle which includes the above different areas. This area is the area of the smallest rectangle which includes all the different areas.

The above method of updating images is as follows:

Step1: if the area of the smallest rectangle is larger than the configured threshold, the system would choose the method of updating the full picture.

Step2: if the area of the smallest rectangle is smaller than the configured threshold, the system would choose the method of updating the partial picture.

The above described electronic products include all the electronic products using electronic paper as their display screens.

This invention is a method of updating images on the electronic paper panel. Compared with the present technology, it has the following advantages and beneficial effect:

This invention is a method of updating images on the electronic paper panel. It divides the image which will display as the next into (N*N) areas and compares it with the present image. Then it records the different areas, uses the smallest rectangle to include them and then compute the area of this rectangle as its area of updating area. If this area is larger than the configured area threshold, the method of updating images in this system would be set up as the method of updating the full picture. If this area is smaller than the configured area threshold, the method of updating images in this system would be set up as the method of updating the partial picture. This invention reduces the data of updating images in electronic products using the electronic paper, the response time of the display screen, the high-power consuming and so on. It provides an effective method of updating images on the electronic paper panel. It has many advantages as follows: improving the response time of the electronic paper panel, reducing the amount of data of updating picture and reducing the power of electronic paper systems, especially the power of the electronic paper panel. This method could be easily ported to other advanced embedded operating systems.

### BRIEF DESCRIPTION OF THE DRAWINGS

FIG. 1 is the flow chart of the system in this invention;

FIG. 2 is the framework of the multimedia CPU of the debug environment in this invention;

FIG. 3 is the framework of the display controller of the debug environment in this invention;

FIG. 4 is the dividing areas of display images;

FIG. 5 is the dividing areas of the image which will be shown next and its different areas from the present one;

FIG. 6 is the case of display image according to this invention;

FIG. 7 is the case of display image according to this invention;

FIG. 8 is the case of display image according to this invention.

### EMBODIMENTS

The following part combines the figures and case to introduce this invention.

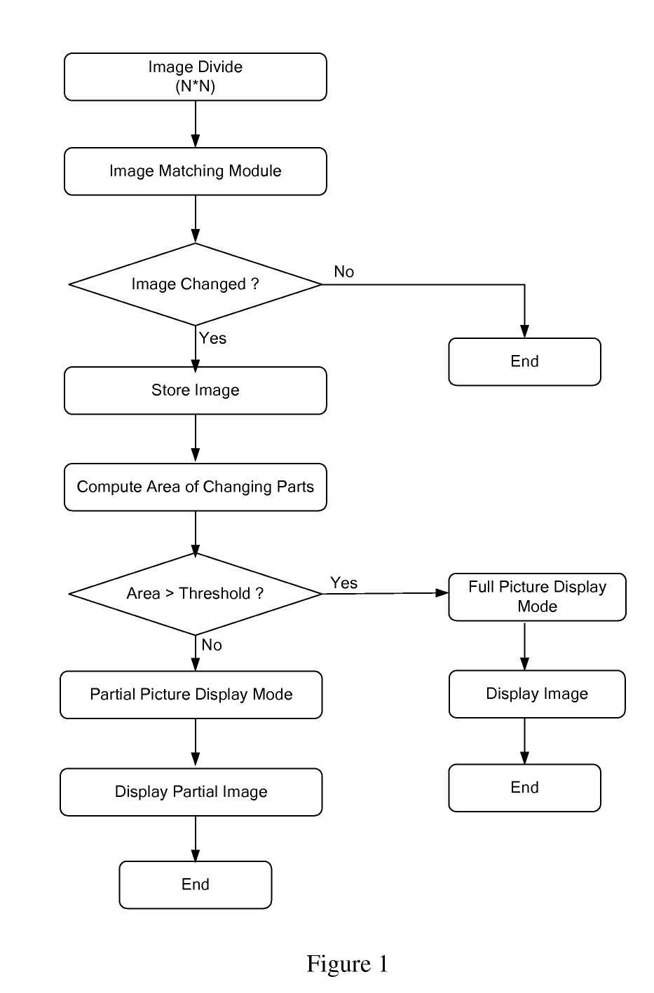

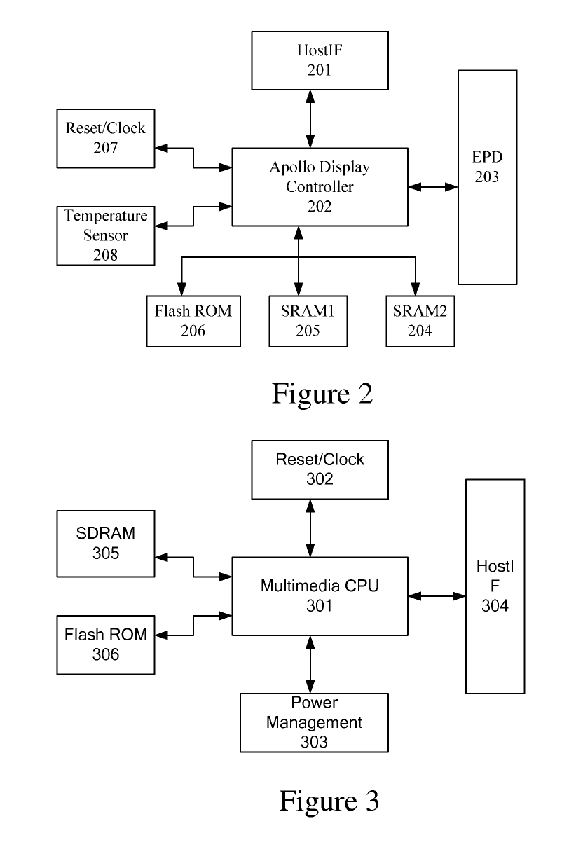

According to the FIG. 1, the flow chart of the system in this invention, the system would divide the image into many parts and compare it with the next image, then decide whether the image will be changed. If the image is changed, the system would store the image, or it would end up. The next step is to compute the area of changing part and decide the method of updating image. If the area of changing part is larger than the configured threshold, the system would use the method of updating the full picture to display the full picture, or it would use the method of updating the partial picture to update the changing part of the picture.

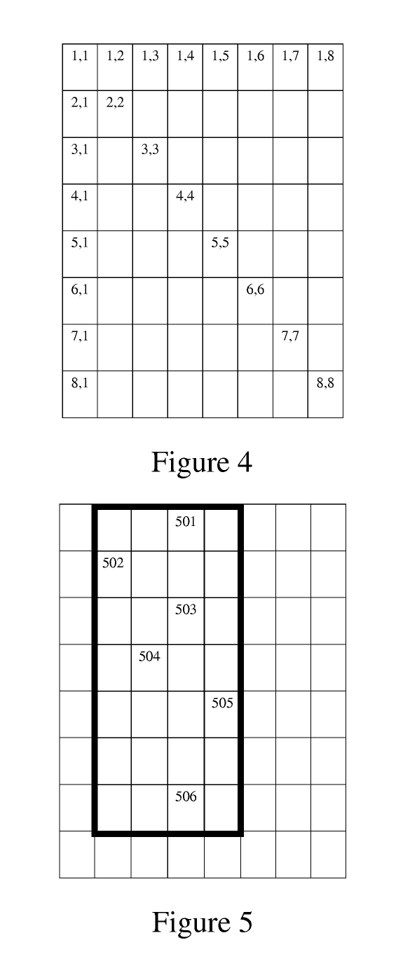

In this use case, the main steps are as follows:
(1) The system divides the next image which will be shown next into N*N (N=8) areas, as shown in FIG. 4. It would make index for these 64 blocks ((1, 1) . . . (8, 8)). Then it compares these blocks with these of the present image to ensure whether they are changed. In FIG. 5, the 501 area, the 502 area, the 503 area, the 504 area and the 506 area are the changed areas.
(2) If the image is changed, the system would store this image.
(3) Compute the area of the updating part of the image as follows:
   Step 1: the system computes the number of the uppermost 501 block, the undermost 506 block, the leftmost 502 block and the rightmost 505 block.
   Step 2: the system computes the area of the rectangle including the above areas. This area is the area of the smallest rectangle including these different blocks. In the FIG. 5, the coarse black rectangle is the area of updating part of the image, including 28 blocks.
(4) The method of updating images on the electronic paper panel is decided as follows:
   Step 1: if the area of the smallest rectangle is larger than the configured threshold, the system would use the method of updating full picture.
   Step 2: if the area of the smallest rectangle is smaller than the configured threshold, the system would use the method of updating the partial picture.
(5) The system will deliver the data of updating image to the memory of the controller on the electronic paper panel and then display the image.

The FIG. 3 is the multimedia CPU of the electronic paper in the debug environment. At first, the multimedia CPU 301 runs the operating system from flash memory 306. Then it copies the operating system to the SDRAM 305 and it continues running. The operating system set up the display controller 202 of the electronic paper through the host interface 304. According to the configuration of the operating system, the display controller reads the responding parameters from flash memory 206, SRAM1 205 and SRAM2 204 and controls the electronic paper panel 203 to display images.

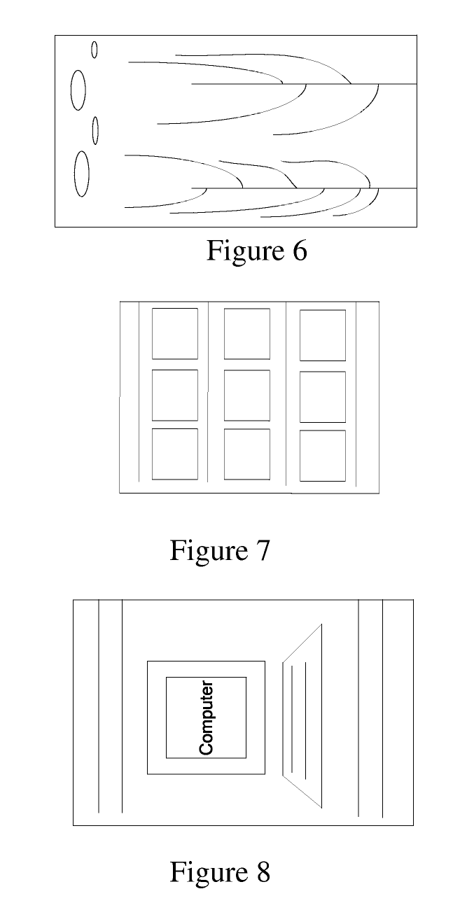

Using this invention of the method of updating images on the electronic paper panel, in the debug environment the system displays the effects of trees as FIG. 6, squares as FIG. 7 and the combination of words and pictures as FIG. 8.

There is a point that the order of the above steps could be changed. Thus, this invention does not limit the order of the above steps, even when the order of the above order is changed, it would not effect the integrated operation of this invention. In addition, the use cases of this invention are demonstrative and the invention is not limited in these cases. Therefore, this invention will not be limited in the above described cases. Other methods created by researchers and engineers using this invention are protected in protected fields of this invention.

1. A method of updating images on an electronic paper panel comprising:
dividing a screen and image into (N*N) areas and building indexes for the (N*N) areas, comparing a present picture and a next picture, computing different areas;
according to the above result, finding uppermost, undermost, leftmost and rightmost different areas; computing the area of the smallest rectangle including the above different areas, wherein the area of the smallest rectangle is the area of an updating part of the image;
comparing the area of the updating part of the image with a configured threshold; and according to the comparison result, setting up an updating method to display the image.

2. A method of updating images according to claim 1, wherein the resolution of the electronic paper panel is in the range from 32*32 pixels to 1920*1920 pixels.

3. A method of updating images according to claim 1, wherein the resolution of the images of the electronic paper panel is in the range from 32*32 pixels to 1920*1920 pixels.

4. A method of updating images according to claim 1, wherein the gray degree and the color depth of the images is in the range from black-white to true color 32-bit.

5. A method of updating images according to claim 1, wherein the algorithm of the smallest rectangle is as follows:
Step1: computing the uppermost, undermost, leftmost and rightmost different area indexes;
Step2: computing the area of the rectangle including the above different areas, wherein the area of this rectangle is the smallest area including all the different areas.

6. A method of updating images according to claim 1, wherein
if the area of the smallest rectangle is larger than the configured threshold, the system would choose the updating method of a full-picture;
if the area of the smallest rectangle is smaller than the configured threshold, the system would choose the updating method of a partial-picture.

7. An electronic paper product comprising the electronic paper panel according to claim 1.

8. A method of updating images according to claim 5, wherein:
if the area of the smallest rectangle is larger than the configured threshold, the system would choose the updating method of a full-picture.
if the area of the smallest rectangle is smaller than the configured threshold, the system would choose the updating method of a partial-picture.
